(19) United States
(12) Patent Application Publication
(10) Pub. No.: US 2005/0193021 A1
(43) Pub. Date: Sep. 1, 2005

(54) Method and apparatus for unified storage of data for storage area network systems and network attached storage systems

(75) Inventor: Nir Peleg, Ha'anafa (IL)

Correspondence Address: SUGHRUE MION, PLLC, 2100 PENNSYLVANIA AVENUE, N.W., SUITE 800, WASHINGTON, DC, 20037, US

(73) Assignee: EXANET CO.

(21) Appl. No.: 10/465,631

(22) PCT Filed: Dec. 20, 2000
(86) PCT No.: PCT/US00/33277

§ 371 Date: Mar. 16, 2005

(51) Int. Cl. G06F 17/30

(52) U.S. Cl. 707/200

(57) ABSTRACT

A unified data storage apparatus for storing data for both storage area network and network attached storage system architectures on the same storage medium. The storage medium (50) is partitioned for storage of logical disk volumes and files (58), and is further partitioned for storage of pointers to logical disk volumes (59).

### BACKGROUND OF THE INVENTION

1. Technical Field of the Invention

This invention is related to a method and apparatus for storing data used by Storage Area Networks and Network Attached Storage systems on the same storage medium. In particular, the storage of data for these two network architectures reduces the number of storage assets required for a network. The invention is embodied in a method for storing data from both Storage Area Network and Network Attached Storage architectures on the same storage medium, and a data storage apparatus for storing data received from both Storage Area Network and Network Attached Storage architectures. The invention is also embodied in a computer system that stores data received from both Storage Area Network and Network Attached Storage architectures on the same storage medium, and a computer program product that stores data from both Storage Area Network and Network Attached Storage architectures.

2. Description of the Related Art

There will now be provided a discussion of various topics to provide a proper foundation for understanding the invention.

In order for a client device to be able to access to multiple servers running different operating systems, either the client device supports the file sharing protocol of each operating system or the server supports the file sharing protocol of each client device. Software that adds this capability is very common and allows interoperability between Windows®, Macintosh®, NetWare® and UNIX platforms. TABLE 1 lists several common operating systems and their transport and file sharing protocols for networking environments.

TABLE 1

| Operating | Transport | File Sharing |
|---|---|---|
| System | Protocol | Protocol |
| DOS | NETBIOS | SMB |
| WINDOWS | NETBEUI | SMB, CIFS |
| NETWARE | IPX | NCP |
| MACINTOSH | APPLETALK | AFP |
| UNIX | TCP/IP | NFS |

A Storage Area Network (SAN) system is a back-end network that uses peripheral channels to connect storage devices. Typically, the peripheral channels are Small Computer System Interface (SCSI), Serial Storage Architecture (SSA), Enterprise Systems Connection (ESCON) and Fibre Channel. SAN devices are usually dedicated high-bandwidth systems that handle traffic between servers and storage assets. Data objects on a SAN system are sets of logical disk volumes above which higher level object semantics can be implemented on specific application servers.

Both centralized SANs and distributed SANs are currently used. A centralized SAN ties multiple hosts into a single storage system. The storage system is usually a Redundant Array of Independent Disks (RAID) device with large amounts of cache and redundant power supplies. Typically, this centralized storage architecture ties a server cluster together for fault tolerance (i.e., if one server fails, another server can take over). Centralized SAN also provides simplified sharing of data between multiple servers, and further provides multiple servers the capability to perform the work on the shared data.

Referring to FIG. 1, a centralized SAN system is illustrated. The applications servers 1,2 and the mainframe computer 6 are connected to the disk array 4 via several peripheral channels 8-10. As described above, the peripheral channels may use SCSI, SSA, ESCON or Fibre Channel protocols to transfer data between the disk array 4 and the applications servers 1,2.

A distributed SAN system connects multiple hosts with multiple storage systems. Referring to FIG. 2, a distributed SAN system is illustrated. Several applications servers 1-3 are connected to a switch 7, which is also connected to several disk arrays 4,5. The switch 7 handles the transfer of data between the multiple disk arrays 4,5 and the applications servers 1-3 via the peripheral channels 8-12. Of course, SAN systems are not limited to only using disk arrays for data storage. For example, a distributed SAN system could be simultaneously connected to both single disk storage systems and disk array storage systems. In addition, a distributed SAN system can be constructed from hubs (which connect to the storage devices via loops), or a combination of hubs and switches.

Referring to FIG. 3, the data path of data objects transferred between an applications server 15 and the disk storage 18 will be described. As noted above, data objects transferred in a SAN system are logical disk volumes. When a data request is received at the disk storage 18 for an identified logical disk volume, the disk storage 18 sends out the volume over peripheral channel 20 into the SAN network 19. When the logical disk volume arrives at the applications server 15, the file manager 17 handles the high-level object semantics necessary to supply the requested data to the software application 16.

A Network Attached Storage (NAS) system is connected to a front-end communications network just like a file server. Typically, the communications protocol is Ethernet, TCP/IP or FTP, but other lesser-used protocols are not excluded. A NAS system does not rely upon a complete operating system for its functionality. Instead, a slimmed-down micro-kernel targeted for file management is used. Traditional Local Area Network (LAN) protocols such as NFS (UNIX), SMB/CIFS (DOS/Windows) and NCP (NetWare) are examples of slimmed-down operating systems used for file management on a NAS system. Devices in a NAS system typically attach to a LAN and allow sets of users to retrieve and share files that may span over multiple operating system environments.

Referring to FIG. 4, a NAS system is illustrated. Several clients 21-22 are connected to a hub 25. The hub 25 is connected to a NAS server 23. The NAS server 23 communicates with a disk array 24 to retrieve data for the clients 21-22 or to store data for the clients 21-22. LAN channels 26-28 realize connections between the NAS server 23, the hub 25 and the clients 21-22.

Referring to FIG. 5, the data path of data objects transferred between a client 33 and the disk storage 32 will be described. Typically, a NAS system exports higher level objects (i.e., files) to the LAN for use by the client systems attached to the LAN. A request for a file stored on the NAS server 30 is received from the NAS network 35. The file manager 31 searches the disk storage 32 for the file, and if located, outputs the file to the NAS network 35 over the LAN channel 36. When the file arrives at the client 33, the software application 34 is able to manipulate the file.

An advantage of the NAS system is that adding or removing a NAS system is like adding or removing any network node. In general, a SAN system (e.g., a channel-attached storage system) must be brought down in order to reconfigure it. Another advantage of a NAS system is that application servers are not involved with management functions, such as volume management, and can access the stored data as files. However, NAS systems are subject to the erratic behavior and overhead of the network.

### SUMMARY OF THE INVENTION

The invention has been made in view of the above circumstances and to overcome the above problems and limitations of the prior art.

Additional aspects and advantages of the invention will be set forth in part in the description that follows and in part will be obvious from the description, or may be learned by practice of the invention. The aspects and advantages of the invention may be realized and attained by means of the instrumentalities and combinations particularly pointed out in the appended claims.

A first aspect of the present invention is a data storage device comprising a first port connected to a storage area network to applications servers and client devices. The data storage device further comprises a storage medium having a first portion that stores files, a second portion that stores logical disk volumes and a third portion that stores pointers to the logical disk volumes.

A second aspect of the present invention is data storage device comprising first and second ports. The data storage device further includes a storage medium connected to the first port and second port, and the storage medium has a first portion that stores files, a second portion that stores logical disk volumes and a third portion that stores pointers to the logical disk volumes.

A third aspect of the present invention is a computer network that includes a storage area network having applications servers, and a network attached storage system having client devices and file servers. The computer network also includes a storage device connected to the storage area network and the network attached storage system. The storage device includes a storage medium having a first portion assigned to files for the client devices, a second portion assigned to logical disk volumes for the applications servers, and a third portion assigned to pointers to the logical disk volumes.

A fourth aspect of the present invention is a storage system responsive to service requests from client devices of a network attached storage system and to applications servers of a storage area network. The storage system includes a first interface to the network attached storage system, a second interface to the storage area network and a storage medium. The storage medium comprises a first portion assigned to store files for the clients of the network attached storage system, a second portion assigned to store logical disk volumes for the applications servers of the storage area network, and a third portion assigned to store pointers to the logical disk volumes.

A fifth aspect of the present invention is a data storage device that includes a first storage medium assigned to files for client devices of a network attached storage system. The data storage device further comprises a second storage medium assigned to logical disk volumes for the applications servers of a storage attached network, and a third storage medium for pointers the logical disk volumes for the applications servers of a storage attached network.

A sixth aspect of the present invention is a storage device including a first interface for connecting to a network attached storage system and a second interface for connecting to a storage area network. The storage device further includes a storage medium having a first portion assigned to store files for the client devices of the network attached storage system, a second portion assigned to store logical disk volumes for the applications servers of the storage area network and a third portion assigned to store pointers to the logical disk volumes. The storage device also includes a controller connected to the first and second interface for controlling read and write access to the storage medium.

A seventh aspect of the present invention is a data storage device having a first port and storage means connected to the first port. The storage means includes a first portion that stores the files, a second portion that stores the logical disk volumes and a third portion that stores pointers to the logical disk volumes.

An eighth aspect of the present invention is a storage system responsive to service requests from client means of a network attached storage system and to applications servers of a storage area network. The storage device has a first interface means and second means for connecting to the networks. The storage device has storage means for storing files and logical disk volumes, and storage means is partitioned into a first portion assigned to store the files for the client means, a second portion assigned to store the logical disk volumes for the applications servers and a third portion assigned to store pointers to the logical disk volumes.

A ninth aspect of the present invention is a storage device having a first and second interface means for connecting to network attached storage systems and to storage area networks. The storage device includes a storage means for storing files and logical disk volumes, and the storage means is partitioned into a first portion assigned to store files for the client means, a second portion assigned to store logical disk volumes for the applications servers and a third portion assigned to store pointers to the logical disk volumes. The storage device also includes a controller means connected to the first and second interface for controlling read and write access to the storage means.

A tenth aspect of the present invention is a method of storing data from a plurality of storage systems on a storage medium. The method comprises storing data for client devices of a network attached storage system on a first portion of the storage medium, storing data for applications servers of a storage area network on a second portion of the storage medium, and storing pointers to data for applications servers on a third portion of the storage medium.

A eleventh aspect of the present invention is a computer system adapted to storing data from a plurality of storage systems on a storage medium. The computer system comprises a processor and a memory comprising software instructions adapted to enable the computer system to store data for client devices of a network attached storage system on a first portion of the storage medium. The instructions are further adapted to enable the computer system to store data for applications servers of a storage area network on the second portion of a storage medium, and to store pointers to data for applications servers on a third portion of the storage medium.

A twelfth aspect of the present invention is a computer program product for storing data from a plurality of storage systems on a storage medium. The computer program product comprises software instructions for enabling a computer system to perform predetermined operations, and a computer readable medium bearing the software instructions. The predetermined operations comprise storing data for client devices of a network attached storage system on a first portion of the storage medium, storing data for applications servers of a storage area network on a second portion of the storage medium, and storing pointers to data for applications servers on a third portion of the storage medium.

A thirteenth aspect of the present invention is a executable program for a computer system for storing data from a plurality of storage systems on a storage medium. The executable program comprises a first executable code portion which, when executed on the computer system, stores data for client devices of a network attached storage system on a first portion of the storage medium. The executable program further comprises a second executable code portion which, when executed on the computer system, stores data for applications servers of a storage area network on a second portion of the storage medium. The executable program further comprises a third executable code portion which, when executed on the computer system, stores pointers to data for applications servers on a third portion of the storage medium.

A fourteenth aspect of the present invention is a method for handling data requests from a plurality of data requestors to a storage device. The method comprises receiving the data request and determining if the data request originates from an application server of a storage attached network or a client device. If the data request originated from an application server and requests a volume, the method further comprises determining if the requested volume is stored on the storage device, and retrieving the volume using a pointer to the volume. If the data request originated from the client device and requests a file, the method further comprises retrieving the requested file from the storage device.

A fifteenth aspect of the present invention is a method for handling data write requests from a plurality of data writers to a storage device. The method comprises receiving the data write request and determining if the data write request originates from an application server of a storage attached network or a client device. If the data write request originated from an application server and requests to write a volume to the storage device, the method further comprises determining if the volume is already stored on the storage device, determining if the storage device has space for storing the volume, writing the volume to the storage device, and updating a pointer to the volume. If the data write request originated from a client and requests to write a file to the storage device, the method further comprises writing the requested file to the storage device.

The above aspects and advantages of the invention will become apparent from the following detailed description and with reference to the accompanying drawing figures.

### BRIEF DESCRIPTION OF THE DRAWINGS

The accompanying drawings, which are incorporated in and constitute a part of this specification, illustrate the invention and, together with the written description, serve to explain the aspects, advantages and principles of the invention. In the drawings,

FIG. 1 illustrates a conventional centralized SAN system with several servers and a disk array;

FIG. 2 illustrates a conventional distributed SAN system with several servers and multiple disk arrays;

FIG. 3 illustrates how data objects are passed from disk storage to the application on a conventional SAN system;

FIG. 4 illustrates a conventional NAS system with several clients and a NAS server;

FIG. 5 illustrates how data objects are passed from disk storage to the application on a conventional NAS system;

FIG. 6 illustrates a computer network according to an aspect of the invention, with an NAS server, client devices, a storage device and applications servers attached to a LAN;

FIG. 7 illustrates a data storage device according to an aspect of the invention;

FIG. 8 illustrates a SAN network with applications servers and a LAN network with a NAS server and client devices, with a storage device attached to both the SAN network and the LAN network;

FIG. 9 illustrates a data storage device according to another aspect of the invention;

FIG. 10 illustrates the partitioning of the storage medium for handling logical disk volumes and files, according to an aspect of the invention;

FIG. 11 illustrates the basic process flow for storing data from either an application server or a client device;

FIG. 12 illustrates the basic process flow for handling a data request from either an application server or a client device; and

FIGS. 13A-13B illustrate the basic process flow for handling a data storage request from either an application server or a client device.

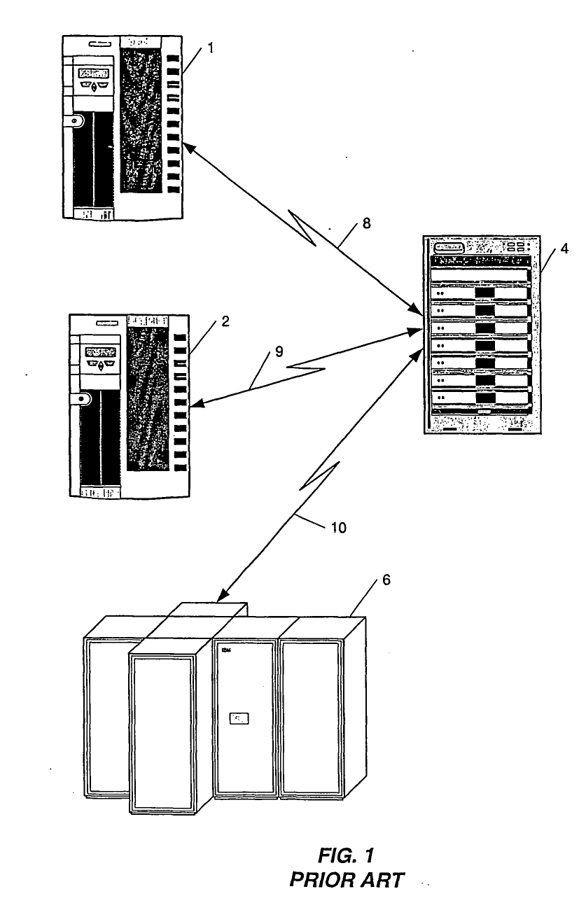

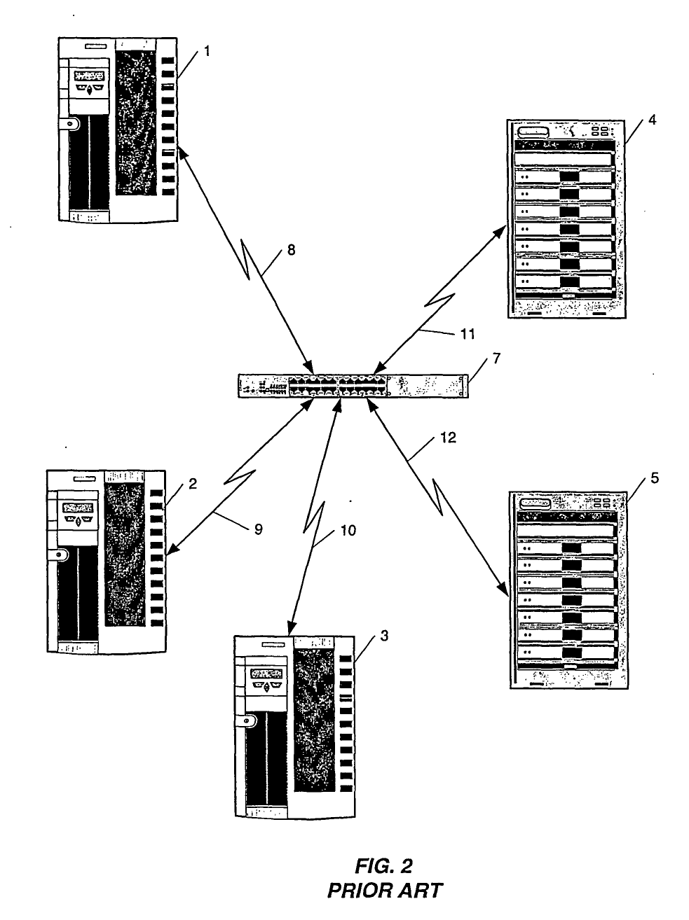

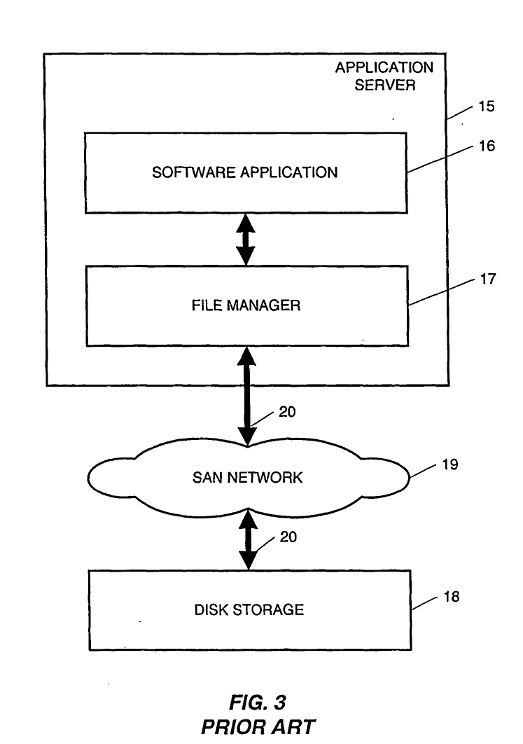

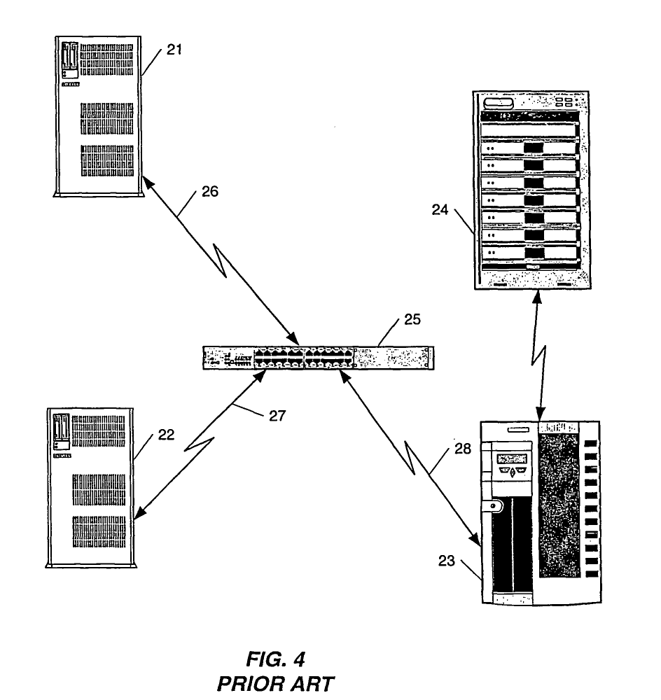

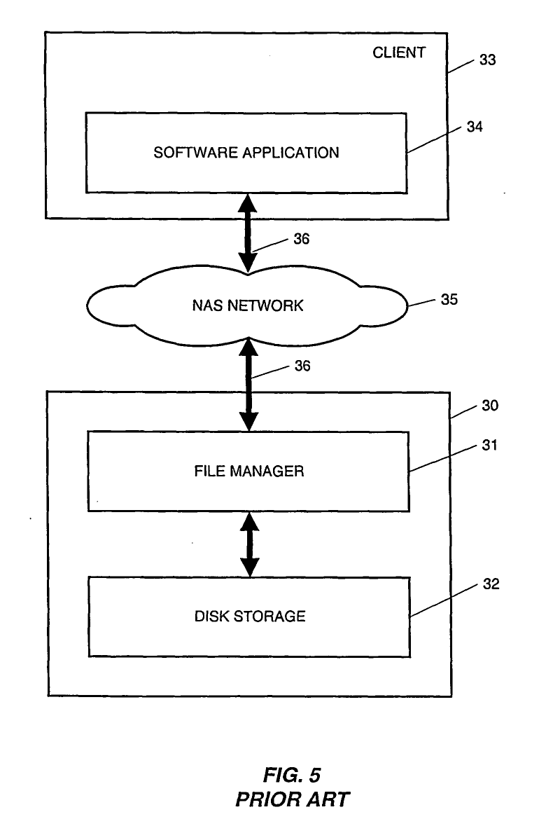

### DETAILED DESCRIPTION OF THE INVENTION

Prior to describing the aspects of the invention, some details concerning the prior art will be provided to facilitate the reader's understanding of the invention and to set forth the meaning of various terms.

As used herein, the term “computer system” encompasses the widest possible meaning and includes, but is not limited to, standalone processors, networked processors, mainframe processors, and processors in a client/server relationship. The term “computer system” is to be understood to include at least a memory and a processor. In general, the memory will store, at one time or another, at least portions of executable program code, and the processor will execute one or more of the instructions included in that executable program code.

As used herein, the term “embedded computer system” includes, but is not limited to, an embedded central processor and memory bearing object code instructions. Examples of embedded computer systems include, but are not limited to, personal digital assistants, cellular phones and digital cameras. In general, any device or appliance that uses a central processor, no matter how primitive, to control its functions can be labeled has having an embedded computer system. The embedded central processor will execute one or more of the object code instructions that are stored on the memory. The embedded computer system can include cache memory, input/output devices and other peripherals.

As used herein, the terms “predetermined operations,” the term “computer system software” and the term “executable code” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

As used herein, the terms “media,” “medium” or “computer-readable media” include, but is not limited to, a diskette, a tape, a compact disc, an integrated circuit, a cartridge, a remote transmission via a communications circuit, or any other similar medium useable by computers. For example, to distribute computer system software, the supplier might provide a diskette or might transmit the instructions for performing predetermined operations in some form via satellite transmission, via a direct telephone link, or via the Internet.

Although computer system software might be “written on” a diskette, “stored in” an integrated circuit, or “carried over” a communications circuit, it will be appreciated that, for the purposes of this discussion, the computer usable medium will be referred to as “bearing” the instructions for performing predetermined operations. Thus, the term “bearing” is intended to encompass the above and all equivalent ways in which instructions for performing predetermined operations are associated with a computer usable medium.

Therefore, for the sake of simplicity, the term “program product” is hereafter used to refer to a computer-readable medium, as defined above, which bears instructions for performing predetermined operations in any form.

As used herein, a “redundant array of independent disks” (RAID) is a disk subsystem that increases performance and/or provides fault tolerance. RAID is a set of two or more hard disks and a specialized disk controller that contains the RAID functionality.

A detailed description of the aspects of the invention will now be given referring to the accompanying drawings.

As described earlier, in a SAN network, the applications servers are connected to the mass storage devices through the SAN network. In a NAS system, the client servers are connected to the storage devices on a LAN. It is not uncommon for both types of networks to comprise a complete system. For example, the application servers a SAN system (which are connected to the SAN network) may be also connected to a LAN in order to communicate amongst themselves. In another example, in a NAS system, a separate SAN network may be connected behind the NAS server. In this architecture, the SAN network is used to connect several storage devices to the NAS server (or sometimes more than one NAS server).

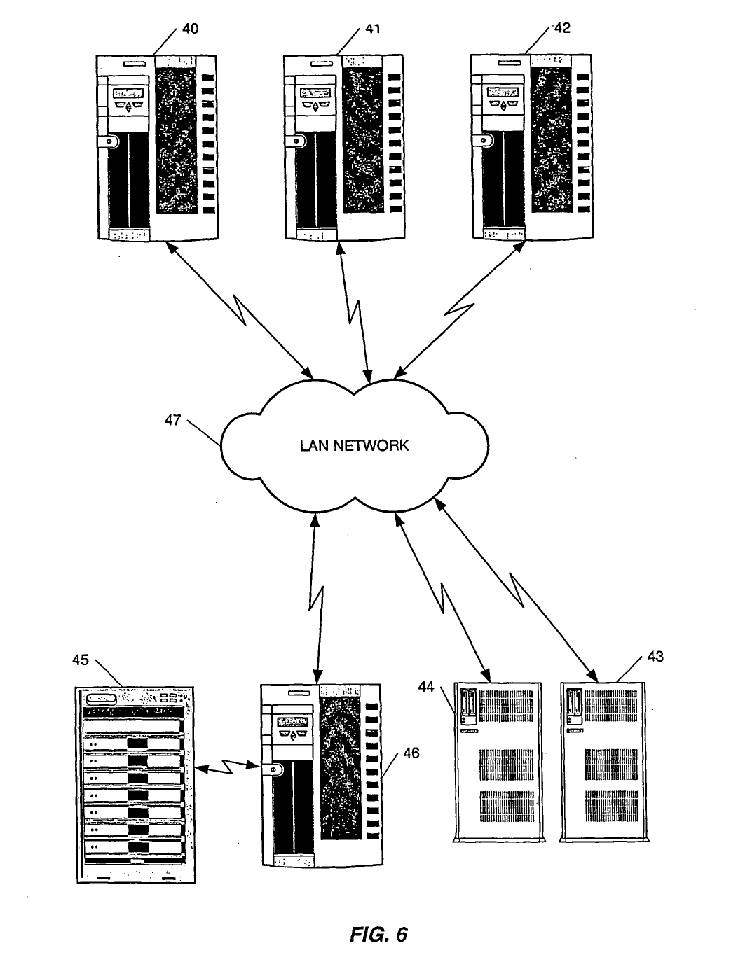

Referring to FIG. 6, a network incorporating the present invention is illustrated. The exemplary network comprises several applications servers 40-42, several client devices 43-44, a data storage device 45 and a NAS server 46. A LAN network 47 interconnects all the components. The data storage device 45 comprises an access port 48 (not shown) connected to the NAS server 46. The data storage device 45 further comprises a storage medium 50 (not shown) that is connected to the access port 48, thereby allowing the applications servers 40-42 and the client devices 43-44 access to the storage medium 50. The NAS server 46 uses the storage device 45 with file types of accesses, as in a normal NAS system. The application servers 40-42 use the LAN network 47 to access the storage device 45 with volume types of accesses. The SAN volume partitions and pointers on the storage medium are used to support these accesses. Typically, the storage medium 50 is a hard disk or a RAID device, although other types of storage mediums (e.g., optical disks, tape storage, semiconductor memory) could be used as well.

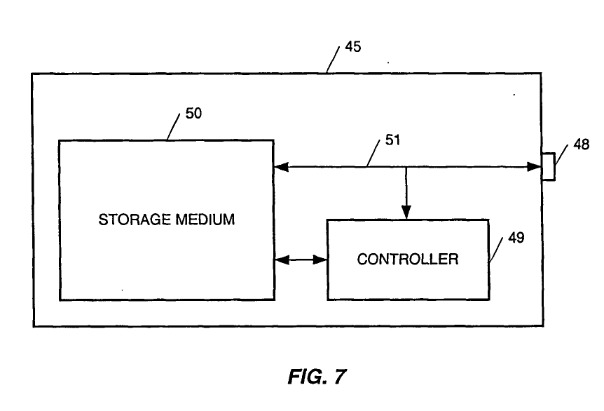

The storage device 45 as shown in the network above will now be described in more detail. Referring to FIG. 7, in order to access the data stored on the storage medium 50, the data storage device 45 further comprises a controller 49 that accesses the storage medium according to commands received from a client device through the access port 48. The bus 51 handles the command and data traffic between the controller 49, the storage medium 50 and the access port 48. The controller 49 reads data (e.g., files) from the storage medium 50 and writes data to the storage medium 50 in accordance with commands received through the storage area network 46 from a client device. In addition, the controller 49 accesses the storage medium according to commands received from an applications server through the access port 48. The controller 49 reads a volume from the storage medium 50 or writes volume to the storage medium 50 in accordance with commands received via the NAS server, and through the LAN (not shown in this Fig, but shown in FIG. 6) from an applications server. The data storage device 45 also comprises a file manager to manage the volumes and files stored on the storage medium 50 (i.e, read files, write files, change attributes such as read/write access, etc.). As will be described below, the storage medium 50 comprises a NAS file partition 57 assigned for storing files for the clients of the network attached storage system, a SAN volume partition 58 assigned for storing volumes for the applications servers of the storage area network, and a SAN pointer partition 59 assigned for storing pointers to the volumes.

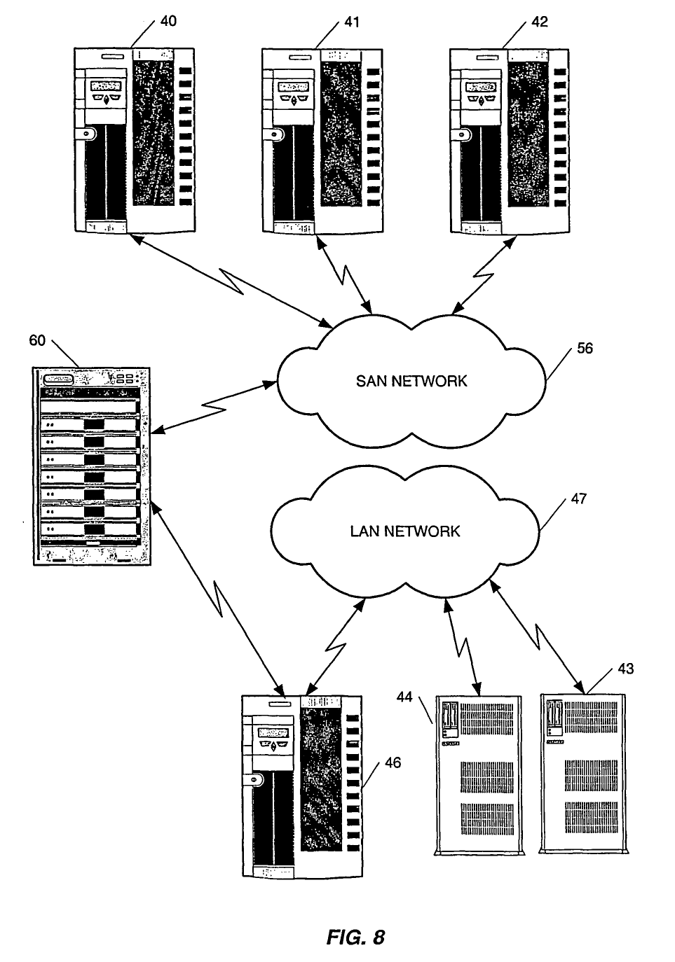

Referring to FIG. 8, another network incorporating the present invention is illustrated. The exemplary network comprises several applications servers 40-42, several client devices 43-44, a data storage device 60 and a NAS server 46. A LAN network 47 interconnects the client devices 43-44 and the NAS server 46. A SAN network 56 interconnects the applications servers 40-42. The data storage device 60 comprises access ports 54,55 (not shown) connected to the LAN network 47 and the SAN network 56, respectively. The data storage device 60 further comprises a storage medium 50 that is connected to the access ports 54,55, thereby allowing the applications servers 40-42 and the client devices 43-44 access to the storage medium 50. Typically, the storage medium 50 is a hard disk or a RAID device, although other types of storage mediums (e.g., optical disks, tape storage, semiconductor memory) could be used as well.

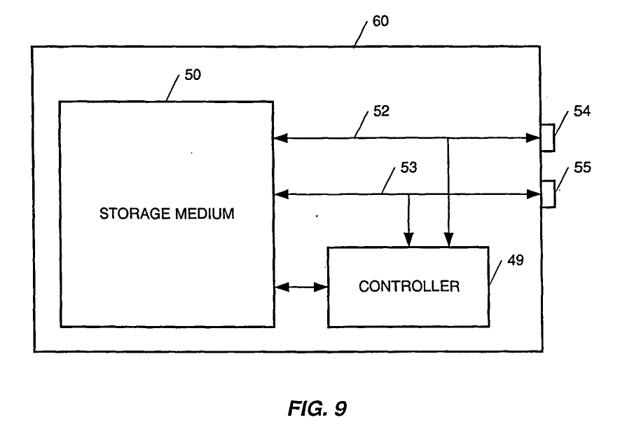

The storage device 60 as shown in the network above will now be described in more detail. Referring to FIG. 9, the data storage device 60 is connected to the clients of a network attached storage system (not shown) and to the applications servers of a storage area network (not shown). The data storage device 60 further comprises a NAS access port 54 to interface with the network attached storage system, and a SAN access port 55 to interface with the storage area network. As will be described below, the storage medium 50 comprises a NAS file partition 57 assigned for storing files for the clients of the network attached storage system, a SAN volume partition 58 assigned for storing volumes for the applications servers of the storage area network, and a SAN pointer partition 59 assigned for storing pointers to the volumes.

The data storage device 60 also comprises a controller 49 to process data requests from the clients of the network attached storage system and the applications servers of the storage area network. The controller 49 stores a file to or retrieves a file from the NAS file partition 57 of the storage medium 50 in response to a command from a client device. In addition, the controller 49 stores a volume to or retrieves a volume from the SAN volume partition 58 of the storage medium 50 in response to a command from an applications server. The controller 49 also updates the SAN pointer partition 59 of the storage medium 50 in response to a command from an applications server to retrieve or store a volume on the storage medium 50. The NAS bus 52 handles the command and data traffic between the controller 49, the storage medium 50 and the NAS access port 54. The SAN bus 53 handles the command and data traffic between the controller 49, the storage medium 50 and the SAN access port 55.

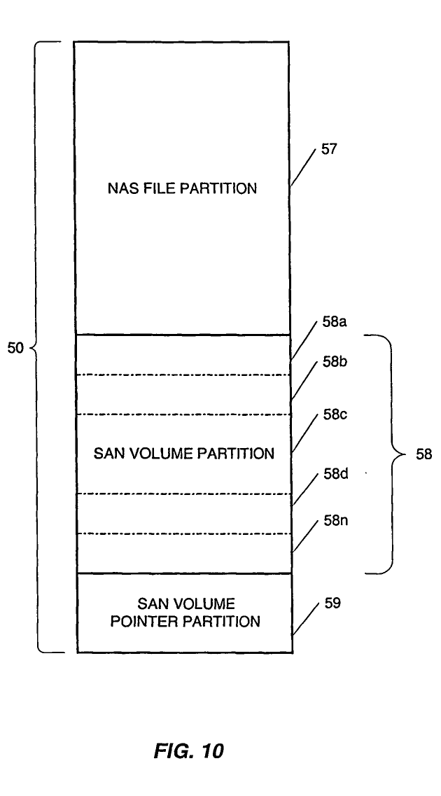

Referring to FIG. 10, the storage medium 50 comprises NAS file partition 57 that is assigned to store files for the client devices 43-44. The storage medium 50 also comprises a SAN volume partition 58 that is assigned to store volumes for the applications servers 40-42. As shown in FIG. 10, multiple volumes 58a-58n are stored in the SAN volume partition 58. These volumes 58a-58n are forwarded to the applications servers 40-42 when requested. The storage medium 50 further comprises a SAN pointer partition 59 assigned to store pointers for the volumes 58a-58n for the applications servers 40-42. In a multiple storage medium environment, partitioning as illustrated in FIG. 10 is duplicated on each storage medium in the multiple storage medium environment. For example, if you have eight hard disk drives, each hard disk drive will have a dedicated NAS file partition 57, a SAN volume partition 58 and a SAN pointer partition 59.

The storage medium 50 is a hard disk or a RAID device, although other types of storage mediums (e.g., optical disks, semiconductor memory, tape storage) could be used as well. If a plurality of hard disks are used as the storage medium, the NAS file partition 57 can simply be assigned to one or more of the disks comprising the plurality of disk drives. Likewise, the SAN volume partition 58 and the SAN pointer partition 59 can be assigned to one or more of the disk drives comprising the plurality of disk drives.

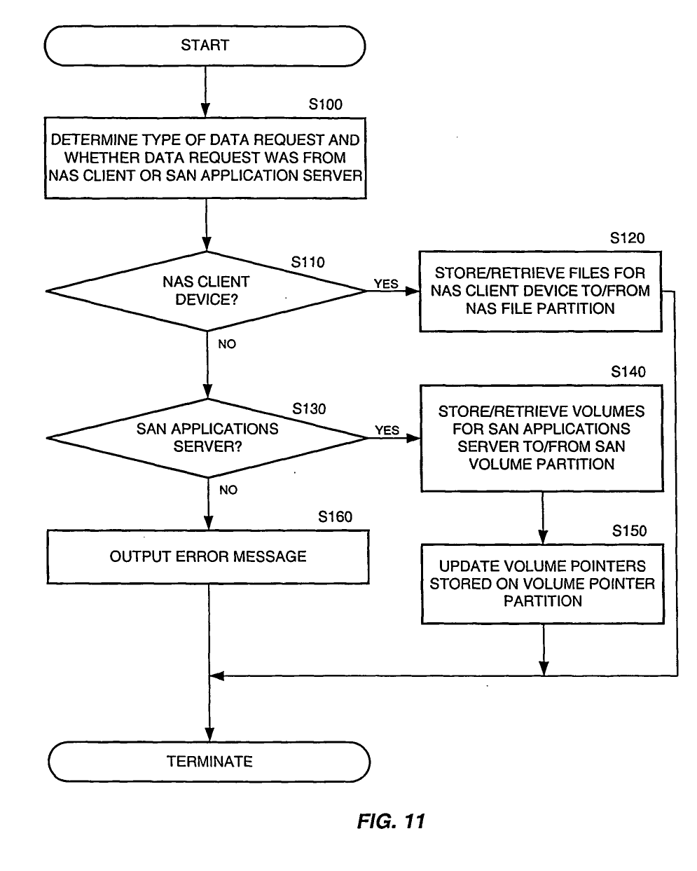

Referring to FIG. 11, another aspect of the invention will now be described. Since the present invention stores data that is assigned to both client devices of a network attached storage system and the application servers of a storage area network, the data storage device must sort through the different types of data and store them in their proper partitions. At S100, a determination is made of what type of data management request is being made (i.e., store data, retrieve data, change attributes, etc.) and from which type of network the data management request originates. Based on that determination, at S110, if the data management request originated from a NAS client device, than at S120, the data storage device 50 performs the requested data management function on the NAS file partition 57. If the data management request was not from a NAS client, the method shifts to S130.

At S130, if the data management request was from an applications server of the storage area network, at S140, the data storage device 50 performs the requested data management function on the SAN volume partition 58. Once the requested data management function is complete, at S150, the data storage device 50 updates the SAN pointer partition 59 to reflect any changes made to the SAN volume partition 58. At S160, if the data management request unidentifiable, an error message is output.

Another embodiment of the present invention described above is a computer system that is adapted to storing data from a plurality of storage systems on a storage medium. The computer system comprises a processor and a memory that comprises software instructions adapted to enable the computer system to perform various functions. Aside from the functions that are associated with an operating system, the memory comprises software instructions adapted to store data for client devices of a network attached storage system on a first portion of the storage medium. This first portion of the storage medium would be the NAS file partition 57 on a storage medium 50 in a storage device 45. The software instructions on the memory are also adapted to store data for applications servers of a storage area network on a second portion of a storage medium. This second portion of the storage medium would be the SAN volume partition 58 on a storage medium 50 in a storage device 45. The software instructions on the memory are also adapted to store pointers to data for applications servers on a third portion of a storage medium. This third portion of the storage medium would be the SAN pointer partition 59 on a storage medium 50 in a storage device 45.

To execute the functions described above with respect to storing data on the storage medium, the software instructions are further adapted to enable the computer system to read or write data from the first portion of the storage medium in response to a command from a client device. Again, this first portion of the storage medium would be the NAS file partition 57 on a storage medium 50 in a storage device 45. The software instructions are also adapted to enable the computer system to read or write data from the second portion of the storage medium in response to a command from an applications server. Again, this second portion of the storage medium would be the SAN volume partition 58 on a storage medium 50 in a storage device 45. In addition, the software instructions are further adapted to enable the computer system to update pointers stored on die third portion of the storage medium in response to a command from an applications server to read or write data from the second portion of the storage medium. Again, this third portion of the storage medium would be the SAN pointer partition 59 on a storage medium 50 in a storage device 45.

Another embodiment of the present invention described above is a computer program product for storing data from a plurality of storage systems on a storage medium. The computer program product comprises software instructions for enabling a computer system to perform predetermined operations, and a computer readable medium bearing the software instructions. The computer readable medium can be any one of the mediums described above. The predetermined operations comprise software instructions adapted to store data for client devices of a network attached storage system on a first portion of the storage medium. This first portion of the storage medium would be the NAS file partition 57 on a storage medium 50 in a storage device 45. The predetermined operations further comprise software instructions adapted to store data for applications servers of a storage area network on a second portion of a storage medium. This second portion of the storage medium would be the SAN volume partition 58 on a storage medium 50 in a storage device 45. The predetermined operations further comprise software instructions adapted to store pointers to data for applications servers on a third portion of a storage medium. This third portion of the storage medium would be the SAN pointer partition 59 on a storage medium 50 in a storage device 45.

To execute the functions described above with respect to storing data on the storage medium, the predetermined operations are software instructions further adapted to enable the computer system to read or write data from the first portion of the storage medium in response to a command from a client device. Again, this first portion of the storage medium would be the NAS file partition 57 on a storage medium 50 in a storage device 45. The predetermined operations are software instructions further adapted to enable the computer system to read or write data from the second portion of the storage medium in response to a command from an applications server. Again, this second portion of the storage medium would be the SAN volume partition 58 on a storage medium 50 in a storage device 45. In addition, the predetermined operations are software instructions further adapted to enable the computer system to update pointers stored on the third portion of the storage medium in response to a command from an applications server to read or write data from the second portion of the storage medium. Again, this third portion of the storage medium would be the SAN pointer partition 59 on a storage medium 50 in a storage device 45.

Another embodiment of the present invention described above is an executable program for a computer system for storing data from a plurality of storage systems on a storage medium. The executable program comprises a first executable code portion which, when executed on the computer system, stores data for client devices of a network attached storage system on a first portion of the storage medium. This first portion of the storage medium would be the NAS file partition 57 on a storage medium 50 in a storage device 45. The executable program comprises a second executable code portion which, when executed on the computer system, stores data for applications servers of a storage area network on a second portion of a storage medium. This second portion of the storage medium would be the SAN volume partition 58 on a storage medium 50 in a storage device 45. The executable program comprises a third executable code portion which, when executed on the computer system, stores pointers to data for applications servers on a third portion of a storage medium. This third portion of the storage medium would be the SAN pointer partition 59 on a storage medium 50 in a storage device 45.

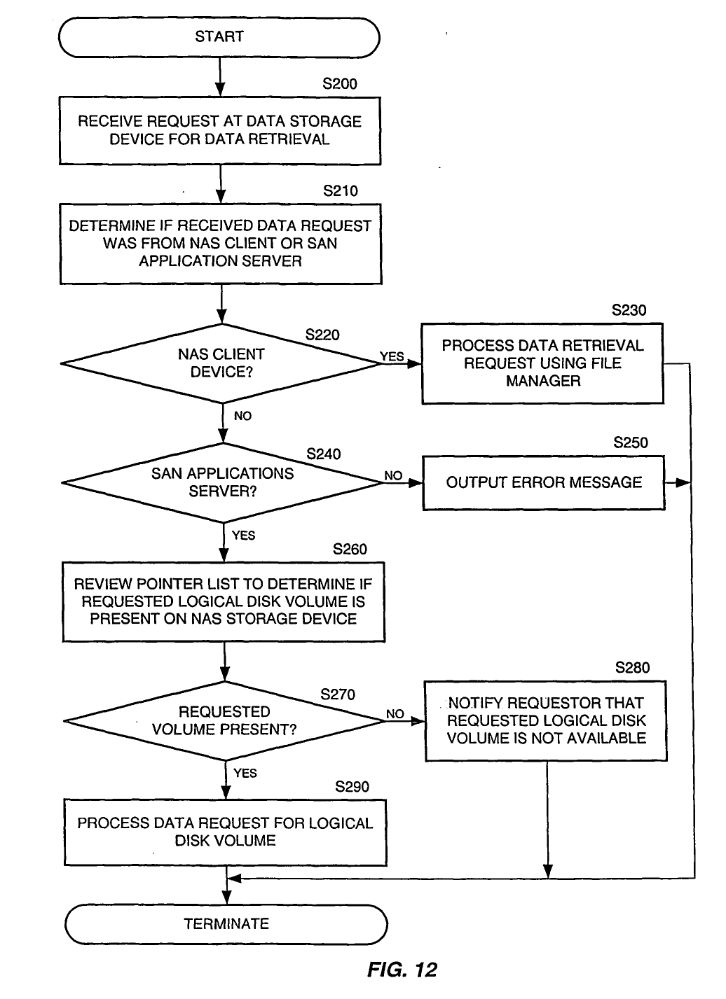

Referring to FIG. 12, another aspect of the invention is illustrated. The present invention must handle data requests from a plurality of data requesters, and provides a method for handling such data requests. At S200, a request for data retrieval is received at the data storage device. At S210, a determination is made whether the request for data retrieval originated from a NAS client device or a SAN applications server. At S220, if the request for data retrieval originated from a NAS client device, the method shifts to S230, where a file manager is used to process the request for data retrieval. If the request for data retrieval did not originate from a NAS client device, the method shifts to S240.

At S240, if the request for data retrieval originated from a SAN applications server, the method shifts to S260, where the pointer list is reviewed to determine if the requested logical disk volume is present on the data storage device. If the request for data retrieval did not originate from a SAN applications server, the method shifts to S250 and an error message is output.

At S260, if the requested logical volume is present, the method shifts to S280, where the request for data retrieval is processed. If the requested logical volume is not present, the method shifts to S290, where the requestor is notified that the requested logical disk volume is unavailable.

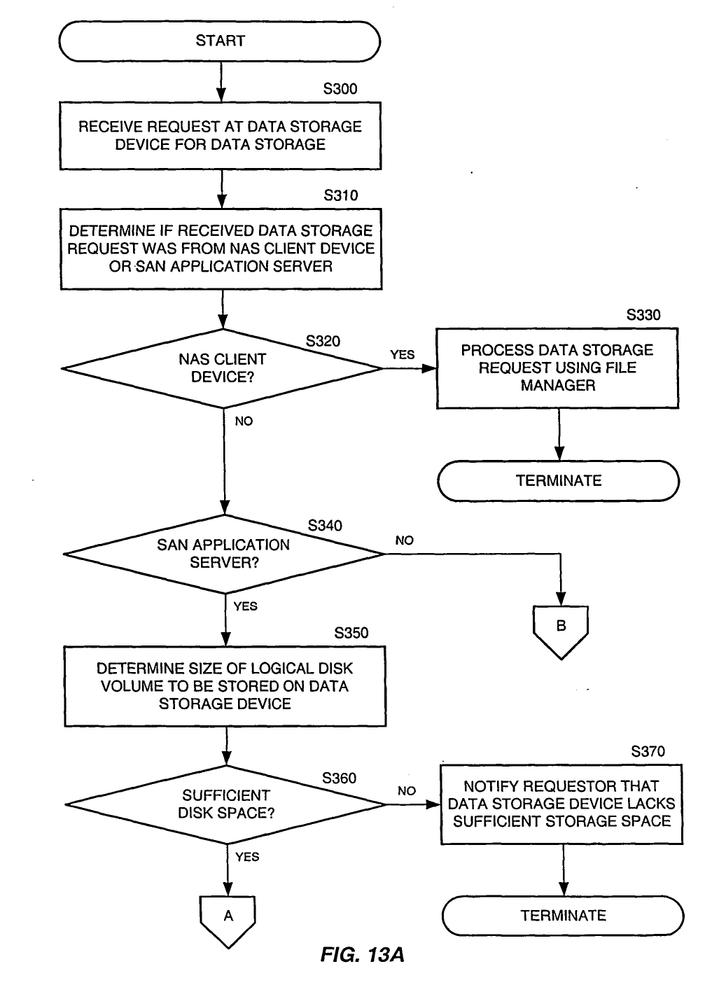

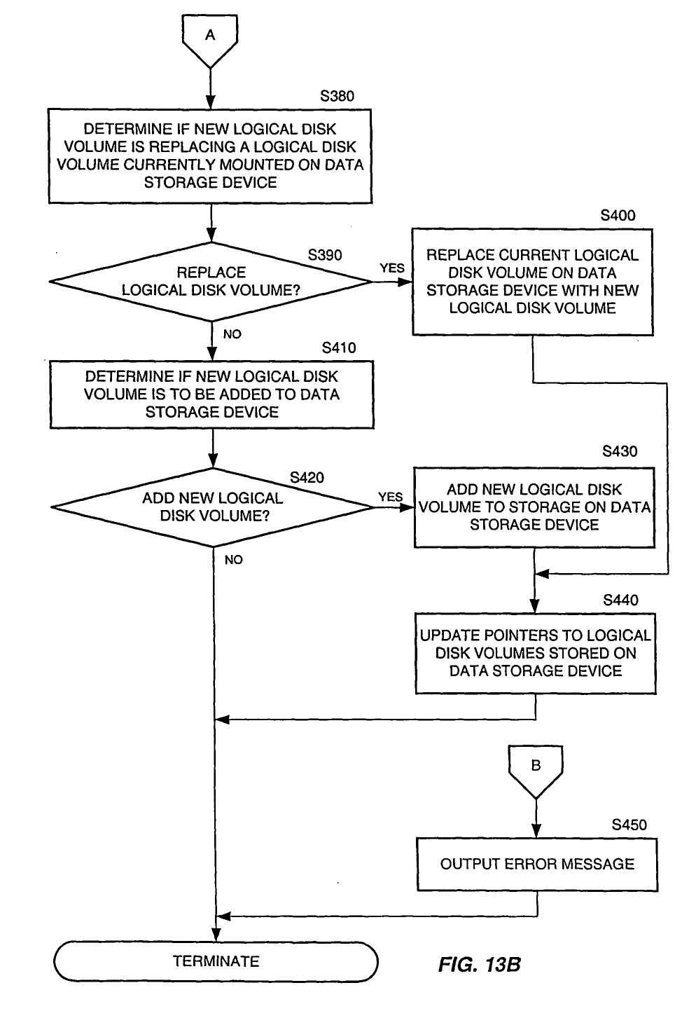

Referring to FIGS. 13A-13B, another aspect of the invention is illustrated. The present invention must handle data writing requests from a plurality of data writers, and provides a method for handling such data writing requests. At S300, a request for data storage is received at the data storage device. At S310, a determination is made whether the request for data storage originated from a NAS client device or a SAN applications server. At S320, if the request for data storage originated from a NAS client device, the method shifts to S330, where a file manager is used to process the request for data storage. If the request for data storage did not originate from a NAS client device, the method shifts to S340.

At S340, if the request for data storage originated from a SAN applications server, the method shifts to S350, where the size of the logical disk volume to be stored is determined. If the request for data storage did not originate from a SAN applications server, the method shifts to S430 and an error message is output.

At S360, if there is insufficient disk space to store the logical disk volume, at S370, the data storage requestor is notified that the data storage device lacks sufficient storage space. If there is sufficient storage space on the data storage device, at S380, a determination is made whether the logical disk volume is replacing a logical disk volume that is currently mounted on the data storage device. At S390, if a currently mounted logical disk volume is to be replaced, the method shifts to S400, where the new logical disk volume replaces the currently mounted logical disk volume. Subsequent to the replacement, as S440, the pointers to the logical disk volumes stored on the data storage device are updated. If the new logical volume does not replace a currently mounted logical volume, the method shifts to S410.

At S410, a determination is made whether the new logical volume is to be stored on the data storage device. At S420, if the new logical volume is to be stored, the method shifts to S430 wherein the new logical volume is stored on the data storage device. At S440, the pointers to the logical disk volumes stored on the data storage device are updated.

The foregoing description of the aspects of the invention has been presented for purposes of illustration and description. It is not intended to be exhaustive or to limit the invention to the precise form disclosed, and modifications and variations are possible in light of the above teachings or may be acquired from practice of the invention. The principles of the invention and its practical application were described in order to explain the to enable one skilled in the art to utilize the invention in various embodiments and with various modifications as are suited to the particular use contemplated.

Thus, while only certain aspects of the invention have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

1. A data storage device, comprising:
a first port; and
a storage medium connected to the first port, comprising:
a first portion that stores files;
a second portion that stores logical disk volumes; and
a third portion that stores pointers to the logical disk volumes.

2. The data storage device as claimed in claim 1, wherein the storage medium comprises a hard disk.

3. The data storage device as claimed in claim 1, wherein the storage medium comprises a redundant array of independent disks.

4. The data storage device as claimed in claim 1, further comprising a file manager that manages the logical disk volumes and files stored on the storage medium.

5. The data storage device as claimed in claim 1, further comprising a controller that controls read and write accesses to the storage medium.

6. The data storage device as claimed in claim 5, wherein the storage device is attached to a network that includes at least one client device, and wherein the controller reads data from the storage medium or writes data to the storage medium according to a command received from at least one client device.

7. The data storage device as claimed in claim 5, wherein the storage device is attached to a network that includes at least one applications server, and wherein the controller reads data from the storage medium or writes data to the storage medium according to a command received from the at least one applications server.

8. A data storage device, comprising:
a first port;
a second port; and
a storage medium connected to the first port and second port, comprising:
a first portion that stores files;
a second portion that stores logical disk volumes; and
a third portion that stores pointers to the logical disk volumes.

9. The data storage device as claimed in claim 8, wherein the storage medium comprises a hard disk.

10. The data storage device as claimed in claim 8, wherein the storage medium comprises a redundant array of independent disks.

11. The data storage device as claimed in claim 8, further comprising a file manager that manages the logical disk volumes and files stored on the storage medium.

12. The data storage device as claimed in claim 8, further comprising a controller that controls read and write accesses to the storage medium.

13. The data storage device as claimed in claim 12, wherein the storage device is attached to a network that includes at least one client device through the first port, and wherein the controller reads data from the storage medium or writes data to the storage medium according to a command received from at least one client device.

14. The data storage device as claimed in claim 12, wherein the storage device is attached to a network that includes at least one applications server through the second port, and wherein the controller reads data from the storage medium or writes data to the storage medium according to a command received from the at least one applications server.

15. A computer network, comprising:
a storage area network comprising at least one applications server;
a network attached storage system comprising:
at least one client device; and
at least one file server; and
a storage device connected to the storage area network and the network attached storage system, the storage device comprising a storage medium having a first portion assigned to files for the at least one client device, a second portion assigned to logical disk volumes for the at least one applications server, and a third portion assigned to pointers to the logical disk volumes.

16. A storage system responsive to service requests from client devices of a network attached storage system and to applications servers of a storage area network, the storage system comprising:
a first interface to the network attached storage system;
a second interface to the storage area network; and
a storage medium comprising:
a first portion assigned to store files for the client devices of the network attached storage system;
a second portion assigned to store logical disk volumes for the applications servers of the storage area network; and
a third portion assigned to store pointers to the logical disk volumes.

17. The storage system as claimed in claim 16, wherein the storage medium comprises a plurality of disk drives.

18. The storage system as claimed in claim 17, wherein the first portion is a selected disk drive from the plurality of disk drives.

19. The storage system as claimed in claim 17, wherein the second portion is a selected disk drive from the plurality of disk drives.

20. The storage system as claimed in claim 17, wherein the third portion is a selected disk drive from the plurality of disk drives.

21. The storage system as claimed in claim 16, further comprising a controller that processes data requests from the client devices of the network attached storage system and the applications servers of the storage area network.

22. The storage system as claimed in claim 21, wherein the controller stores a file to or retrieves a file from the first portion of the storage medium in response to a command from a client device.

23. The storage system as claimed in claim 21, wherein the controller stores a logical disk volume to or retrieves a logical disk volume from the second portion of the storage medium in response to a command from an applications server.

24. The storage system as claimed in claim 23, wherein the controller updates the third portion of the storage medium in response to a command from an applications server to retrieve or store a logical disk volume.

25. A data storage device, comprising:
a first storage medium assigned to files for client devices of a network attached storage system;
a second storage medium assigned to logical disk volumes for applications servers of a storage attached network; and
a third storage medium for pointers the logical disk volumes for the applications servers of the storage attached network.

26. The data storage device as claimed in claim 25, wherein the first, second and third storage mediums comprise at least one disk drive.

27. The data storage device as claimed in claim 25, wherein the at least one disk drive comprises a plurality of disk drives.

28. A storage device, the storage device comprising:
a first interface for connecting to a network attached storage system;
a second interface for connecting to a storage area network;
a storage medium comprising:
a first portion assigned to store files for the client devices of the network attached storage system;
a second portion assigned to store logical disk volumes for the applications servers of the storage area network; and
a third portion assigned to store pointers to the logical disk volumes; and
a controller connected to the first and second interface, wherein the controller manages read and write access to the storage medium.

29. A data storage device, comprising:
a first port; and
a storage means connected to the first port for storing files and logical disk volumes, the storage means comprising:
a first portion that stores the files;
a second portion that stores the logical disk volumes; and
a third portion that stores pointers to the logical disk volumes.

30. The data storage device as claimed in claim 29, wherein the storage means comprises a hard disk.

31. The data storage device as claimed in claim 29, wherein the storage means comprises a redundant array of independent disks.

32. The data storage device as claimed in claim 29, further comprising file manager means for managing the logical disk volumes and files stored on the storage means.

33. The data storage device as claimed in claim 29, further comprising a controller means for controlling read and write accesses to the storage means.

34. The data storage device as claimed in claim 33, wherein the storage means is attached to a network that includes at least one client means, and wherein the controller means reads data from the storage means or writes data to the storage means according to a command received from at least one client means.

35. The data storage device as claimed in claim 33, wherein the storage device is attached to a network that includes at least one applications server, and wherein the controller means reads data from the storage means or writes data to the storage means according to a command received from the at least one applications server.

36. A storage system responsive to service requests from client means of a network attached storage system and to applications servers of a storage area network, the storage system comprising:
a first interface means for connecting to the network attached storage system;
a second interface means for connecting to the storage area network; and
a storage means for storing files and logical disk volumes, the storage means comprising:
a first portion assigned to store the files for the client means of the network attached storage system;
a second portion assigned to store the logical disk volumes for the applications servers of the storage area network; and
a third portion assigned to store pointers to the logical disk volumes.

37. The storage system as claimed in claim 36, further comprising controller means for processing data requests from the client means of the network attached storage system and the applications servers of the storage area network.

38. A storage device, the storage device comprising:
a first interface means for connecting to a network attached storage system;
a second interface means for connecting to a storage area network;
a storage means for storing files and logical disk volumes, the storage means comprising:
a first portion assigned to store files for the client means of the network attached storage system;
a second portion assigned to store logical disk volumes for the applications servers of the storage area network; and
a third portion assigned to store pointers to the logical disk volumes; and
a controller means connected to the first and second interface for controlling read and write access to the storage means.

39. A method of storing data from a plurality of storage systems on a storage medium, the method comprising:
storing data for client devices of a network attached storage system on a first portion of the storage medium;
storing data for applications servers of a storage area network on a second portion of the storage medium; and
storing pointers to data for applications servers on a third portion of the storage medium.

40. The method of storing data as claimed in claim 39, the method further comprising the reading or writing of data from the first portion of the storage medium in response to a command from a client device.

41. The method of storing data as claimed in claim 39, the method further comprising the reading or writing of data from the second portion of the storage medium in response to a command from an applications server.

42. The method of storing data as claimed in claim 39, the method further comprising updating pointers stored on the third portion of the storage medium in response to a command from an applications server to read or write data from the second portion of the storage medium.

43. A computer system adapted to storing data from a plurality of storage systems on a storage medium, the computer system comprising:
a processor;
a memory comprising software instructions adapted to enable the computer system to perform the steps of:
storing data for client devices of a network attached storage system on a first portion of the storage medium;
storing data for applications servers of a storage area network on a second portion of the storage medium; and
storing pointers to data for applications servers on a third portion of the storage medium.

44. The computer system adapted to storing data from a plurality of storage systems on a storage medium as claimed in claim 43, wherein the software instructions are further adapted to enable the computer system to read or write data from the first portion of the storage medium in response to a command from a client device.

45. The computer system adapted to storing data from a plurality of storage systems on a storage medium as claimed in claim 43, wherein the software instructions are further adapted to enable the computer system to read or write data from the second portion of the storage medium in response to a command from an applications server.

46. The computer system adapted to storing data from a plurality of storage systems on a storage medium as claimed in claim 43, wherein the software instructions are further adapted to enable the computer system to update pointers stored on the third portion of the storage medium in response to a command from an applications server to read or write data from the second portion of the storage medium.

47. A computer program product for storing data from a plurality of storage systems on a storage medium, the computer program product comprising:
software instructions for enabling a computer system to perform predetermined operations, and a computer readable medium bearing the software instructions;
the predetermined operations comprising:
storing data for client devices of a network attached storage system on a first portion of the storage medium;
storing data for applications servers of a storage area network on a second portion of the storage medium; and
storing pointers to data for applications servers on a third portion of the storage medium.

48. An executable program for a computer system for storing data from a plurality of storage systems on a storage medium, the executable program comprising:
a first executable code portion which, when executed on a computer system, stores data for client devices of a network attached storage system on a first portion of the storage medium;
a second executable code portion which, when executed on a computer system, stores data for applications servers of a storage area network on a second portion of the storage medium; and
a third executable code portion which, when executed on a computer system, stores pointers to data for applications servers on a third portion of the storage medium.

49. A method for handling data requests from a plurality of data requesters to a storage device, the method comprising:
receiving the data request;
determining if the data request originates from an application server of a storage attached network or a client device;
if the data request originated from an application server and requests a logical disk volume, the method further comprises:
determining if the requested logical disk volume is stored on the storage device; and
retrieving the logical disk volume using a pointer to the logical disk volume; and
if the data request originated from the client device and requests a file, the method further comprises retrieving the requested file from the storage device.

50. A method for handling data write requests from a plurality of data writers to a storage device, the method comprising:
receiving the data write request;
determining if the data write request originates from an application server of a storage attached network or a client device;
if the data write request originated from an application server and requests to write a logical disk volume to the storage device, the method further comprises:
determining if the logical disk volume is already stored on the storage device;
determining if the storage device has space for storing the logical disk volume;
writing the logical disk volume to the storage device; and
updating a pointer to the logical disk volume; and
if the data write request originated from a client and requests to write a file to the storage device, the method further comprises writing the requested file to the storage device.
